(19) United States
(12) Patent Application Publication
(10) Pub. No.: US 2024/0193499 A1
(43) Pub. Date: Jun. 13, 2024

(54) PROCESSING APPARATUS, PROCESSING METHOD AND PROGRAM

(71) Applicant: Nippon Telegraph and Telephone Corporation, Tokyo (JP)

(72) Inventors: Shingo OMATA, Musashino-shi, Tokyo (JP); Ken KANISHIMA, Musashino-shi, Tokyo (JP); Miwaka OTANI, Musashino-shi, Tokyo (JP)

(21) Appl. No.: 18/554,220

(22) PCT Filed: Apr. 7, 2021
(86) PCT No.: PCT/JP2021/014795

§ 371 Date: Oct. 6, 2023

(51) Int. Cl. G06Q 10/06

(52) U.S. Cl. CPC G06Q 10/06

(57) ABSTRACT

A processing device includes: an acquisition unit that acquires service operation data input from a user, the service operation data including terms related to a business process to be realized; a specification unit that breaks down the terms included in the service operation data into elements: a subject, a verb, and an object, and specifies a missing element in which the term is not set among the elements; and a complement unit that extracts a record corresponding to the terms included in the service operation data from practice data in which a plurality of records in which a service operation related to a business process realized in the past is associated with elements: a subject, a verb, and an object is accumulated, and complements the service operation data with the term of the missing element in the extracted record.

### TECHNICAL FIELD

The present invention relates to a processing device, a processing method, and a program.

### BACKGROUND ART

There is an organization design method called an enterprise architecture (EA). This design method makes it possible to create an efficient organization by standardizing each element such as resource allocation, operation procedures, and an information system in the organization and promoting overall optimization.

As one layer constituting the enterprise architecture, there is a business architecture (BA). The business architecture is a framework for logically and systematically representing structures such as physical forms or abstract concepts necessary for business activities.

There is an aspect analysis method for generating a business architecture (Non Patent Literature 1). Non Patent Literature 1 discloses a methodology of an aspect analysis method (Appendix B, Introduction to ArchiMate, B. 3 Aspect Analysis Table).

### CITATION LIST

### Non Patent Literature

Non Patent Literature 1: Shuichiro Yamamoto, “Fundamental Knowledge of DX: Digital Transformation Cases and Methods”, Kindai Kagakusha Digital, October 2020

### SUMMARY OF INVENTION

### Technical Problem

However, Non Patent Literature 1 is limited to a methodology of an aspect analysis method. Non Patent Literature 1 does not disclose a specific method for generating a business architecture.

The present invention has been made in view of the above circumstances, and an object of the present invention is to provide a technology capable of supporting the generation of a business architecture.

### Solution to Problem

A processing device of an aspect of the present invention includes: an acquisition unit that acquires service operation data input from a user, the service operation data including terms related to a business process to be realized; a specification unit that breaks down the terms included in the service operation data into elements: a subject, a verb, and an object, and specifies a missing element in which the term is not set among the elements; and a complement unit that extracts a record corresponding to the terms included in the service operation data from practice data in which a plurality of records in which a service operation related to a business process realized in past is associated with elements: a subject, a verb, and an object is accumulated, and complements the service operation data with the term of the missing element in the extracted record.

A processing method of an aspect of the present invention in which a computer acquires service operation data input from a user, the service operation data including terms related to a business process to be realized; the computer breaks down the terms included in the service operation data into elements: a subject, a verb, and an object, and specifies a missing element in which the term is not set among the elements; and the computer extracts a record corresponding to the terms included in the service operation data from practice data in which a plurality of records in which a service operation related to a business process realized in past is associated with elements: a subject, a verb, and an object is accumulated, and complements the service operation data with the term of the missing element in the extracted record.

One aspect of the present invention is a program that causes a computer to function as the above-described processing device.

### Advantageous Effects of Invention

According to the present invention, it is possible to provide a technology capable of supporting the generation of a business architecture.

### BRIEF DESCRIPTION OF DRAWINGS

FIG. 1 is a diagram describing functional blocks of a processing device according to an embodiment of the present invention.

FIG. 2 is a diagram describing an example of a data structure and data for practice data.

FIG. 3 is a diagram describing an example of a data structure and data for industry practice data.

FIG. 4 is a diagram describing an example of a data structure and data for template data.

FIG. 5 is a diagram describing an example of service operation data.

FIG. 6 is a diagram describing service operation data before and after complement of a missing element by a complement unit.

FIG. 7 is an example of a diagram of a business architecture drawn by drawing data.

FIG. 8 is a flowchart describing a processing method by the processing device.

FIG. 9 is a diagram describing a hardware configuration of a computer used in the processing device.

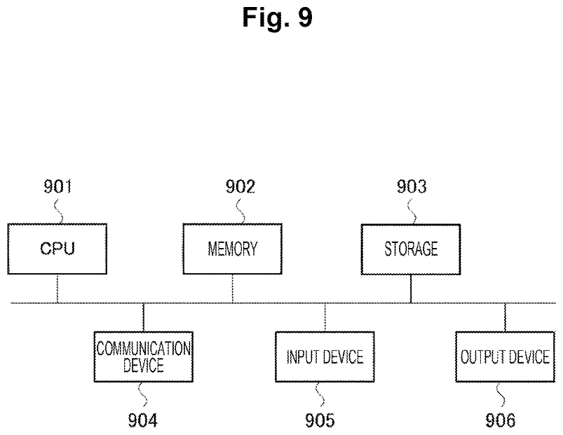

### DESCRIPTION OF EMBODIMENTS

Hereinafter, an embodiment of the present invention will be described with reference to the drawings. In the drawings, the same parts are denoted by the same reference signs, and description thereof is omitted.

### (Processing Device)

A processing device 1 according to the embodiment of the present invention supports formation of a business architecture of an enterprise architecture for a business process to be realized by a user. The processing device 1 performs hearing to each element: behavior (Behavior), passive structure (Passive structure), and active structure (Active structure) for a business process to be realized, and complements a missing element. The processing device 1 generates drawing data 15 that can display a diagram of a business architecture illustrating the association of behavior, passive structure, and active structure.

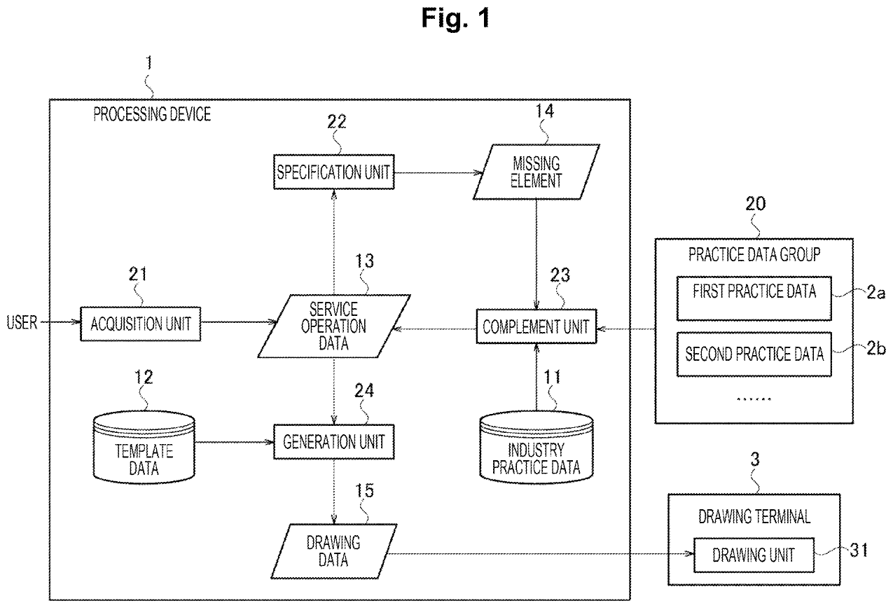

As illustrated in FIG. 1, the processing device 1 refers to a practice data group 20. The practice data group 20 includes a plurality of practice data including first practice data 2a, second practice data 2b . . . . Note that arbitrary practice data included in the practice data group 20 may be referred to as practice data 2.

The practice data 2 may be created for each industry. In addition, a plurality of practice data 2 having different maturation level may be generated for one industry. The practice data 2 is, for example, a TeleManagement Forum (TMF) in the communication industry, a Banking Industry Architecture Network (BIAN) in the bank industry, a Federated Health Information Model (FHIM) in the healthcare industry, or the like. The individual practice data 2 included in the practice data group 20 may be managed at different places such as different uniform resource identifiers (URIs).

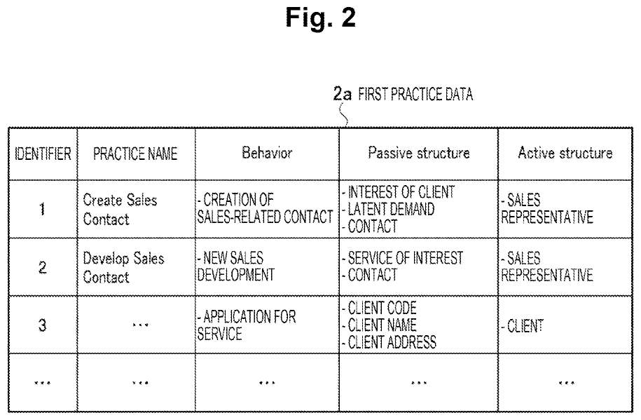

The practice data 2 is data in which a plurality of records in which a service operation related to a business process realized in the past is associated with each element: a subject, a verb, and an object is accumulated. As illustrated in FIG. 2, the practice data 2 is data that associates identifiers of practices realized in the past, practice names thereof, Behavior, Passive structure, and Active structure.

In the embodiment of the present invention, the practice data 2 accumulates data of past service operations related to the business architecture of the enterprise architecture. The active structure (Active structure), the behavior (Behavior), and the passive structure (Passive structure) in the practice data 2 correspond to a subject, a verb, and an object described below, respectively.

The drawing data 15 output from the processing device 1 is drawn by a drawing unit 31 in a drawing terminal 3. The drawing unit 31 is implemented by, for example, a model language capable of displaying a diagram of a business architecture, such as ArchiMate. Note that there are Archi, Signavio, and the like as software for drawing a diagram of business architecture with ArchiMate. Note that a case where the processing device 1 and the drawing terminal 3 are different housings will be described, but it is not limited thereto. The drawing unit 31 may be mounted on the processing device 1.

As illustrated in FIG. 1, the processing device 1 includes data: industry practice data 11, template data 12, service operation data 13, a missing element 14, and the drawing data 15, and functions: an acquisition unit 21, a specification unit 22, a complement unit 23, and a generation unit 24. Each data is stored in a storage device such as a memory 902 or a storage 903. Each function is implemented by a CPU 901.

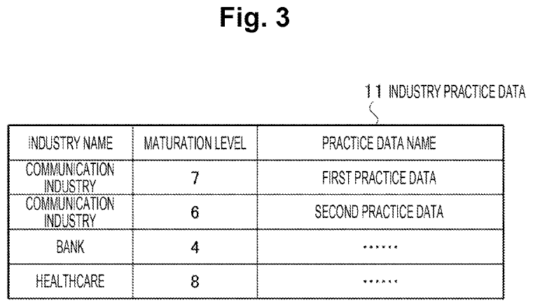

The industry practice data 11 is data in which an identifier of the industry type is associated with an identifier of the practice data 2 in which records of service operations related to the industry type are accumulated. As illustrated in FIG. 3, the industry practice data 11 associates the industry name, which is an identifier of an industry, a maturation level of the practice data 2 regarding the industry, and the identifier of the practice data 2.

The template data 12 is data for generating the drawing data 15 visualizing the business architecture from the service operation data 13. The template data 12 specifies the display position of each element and the direction of a connector of each element of the service operation data 13. In the template data 12, for example, the display position of a verb may be set below the display position of a subject, and the display position of an object may be set below the display position of the verb.

In addition, the template data 12 may be set such that the display position related to each service operation data 13 is displayed from left to right in the order in which the service operation data 13 is input. The template data 12 may be set to display an arrow from the display portion of the verb of certain service operation data 13 to the display portion of the verb of the next service operation data. In the template data 12, a method of changing a name to be displayed on a label may be set from a term of each element displayed in the drawing data 15.

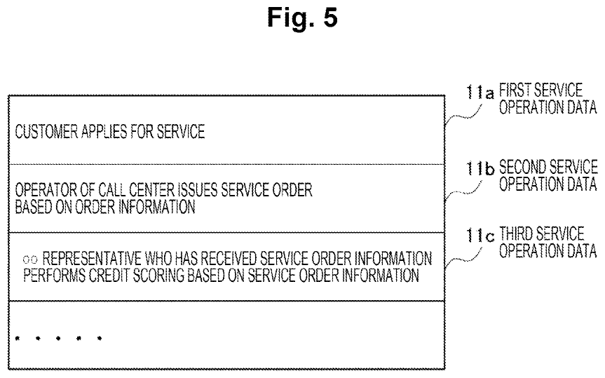

The service operation data 13 is data including terms related to a business process to be realized. Business processes are specified by “Active structure”, “Behavior”, and “Passive structure”. “Active structure”, “Behavior”, and “Passive structure” correspond to a subject, a verb, and an object in a sentence describing a business process. In the service operation data 13, three elements: the subject, the verb, and the object are obtained. The service operation data 13 is input by a user. As illustrated in FIG. 5, the processing device 1 may store a plurality of service operation data 13 including first service operation data 11a, second service operation data 11b, third service operation data 11c, . . . , and the like. Note that arbitrary service operation data included in the processing device 1 may be referred to as service operation data 13.

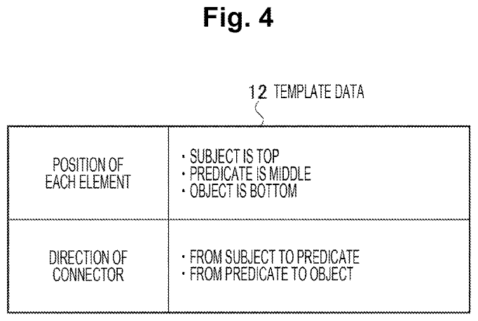

The template data 12 illustrated in FIG. 4 is expressed by “subject”, “verb”, and “object”, but may be expressed by “Active structure”, “Behavior”, and “Passive structure” according to the business architecture.

The missing element 14 is data for specifying a missing element among a plurality of elements required in the service operation data 13. In the embodiment of the present invention, the service operation data 13 needs to include three elements: the subject, the verb, and the object. In given service operation data 13, when there is a subject and a verb and there is no object, the missing element 14 for this service operation data 13 is data that specifies the object.

The drawing data 15 is data capable of displaying a diagram of a business architecture based on the service operation data 13. The drawing data 15 can display a diagram of the business architecture by being read by a tool such as ArchiMate.

The acquisition unit 21 acquires the service operation data 13 input from the user and including the term related to the business process to be realized. The acquisition unit 21 may further acquire from the user the identifier of the industry type related to the business process to be realized.

There is no limitation on means by which the acquisition unit 21 acquires the service operation data 13 from the user. The acquisition unit 21 may display a text box asking a business process that the user desires to realize on a display device that can be visually recognized by the user, and acquire data input by the user with an input device such as a keyboard as the service operation data 13. In addition, the acquisition unit 21 may reproduce a message asking a business process to a speaker that the user can hear and acquire data input by the user with an input device such as a microphone as the service operation data 13. The acquisition unit 21 similarly inquires of the user about the industry type.

The acquisition unit 21 may display or reproduce a message prompting clear input of a subject, a verb, and an object, such as “{person, organization, solution} performs {processing} based on {information}”, as far as possible.

The specification unit 22 breaks down the terms included in the service operation data 13 into the elements: the subject, the verb, and the object, and specifies the missing element 14 in which the term is not set among the elements.

The specification unit 22 breaks down each service operation data 13 input by the user into a subject, a verb, and an object by syntax analysis of a natural language processing technology. The syntax analysis uses dependency syntax analysis, phrase structure analysis, and the like. The specification unit 22 specifies an element to which no term is assigned among the three elements: the subject, the verb, and the object as the missing element 14 for each service operation data 13.

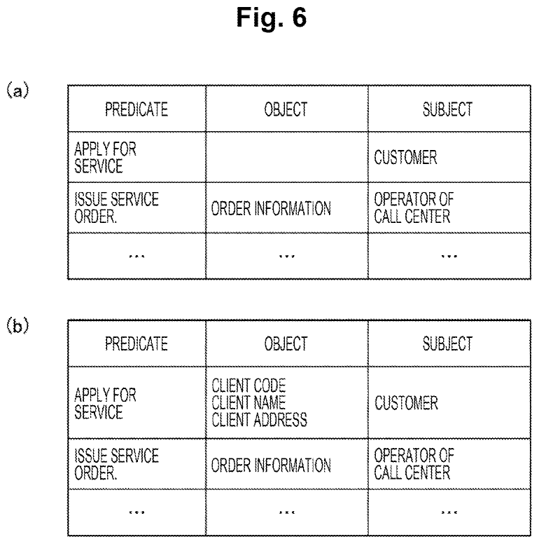

This will be described with reference to FIG. 6 (a). For example, there is service operation data 13 that “a customer applies for service”. The specification unit 22 analyzes that the subject is “customer” and the verb is “apply for service”. Since the object is missing in the service operation data 13, the specification unit 22 sets the object to the missing element 14. In addition, there is service operation data 13 that “an operator of a call center issues a service order based on order information”. The specification unit 22 analyzes that the subject is “operator of a call center”, the verb is “issue a service order”, and the object is “order information”. Since the elements: the subject, the verb, and the object are obtained in the service operation data 13, the specification unit 22 determines that there is no missing element.

The subject, the verb, and the object in the service operation data are respectively active structure (Active structure), behavior (Behavior), and passive structure (Passive structure) in a business architecture of an enterprise architecture. Note that the table illustrated in FIG. 6 (a) becomes an aspect analysis table in the business architecture of the enterprise architecture when “subject” is changed to “Active structure”, “verb” is changed to “Behavior”, and “object” is changed to “Passive structure”.

The complement unit 23 extracts a record corresponding to a term included in the service operation data 13 from the practice data 2, and complements the service operation data 13 with the term of the missing element 14 in the extracted record.

With reference to the practice data 2, the complement unit 23 extracts a record corresponding to a term included in the service operation data 13 for an element other than the element set as the missing element 14 among the three elements: the subject, the verb, and the object. Here, the practice data 2 includes items of “Active structure”, “Behavior”, and “Passive structure” in the business architecture.

Since the subject “customer” and the verb “apply for service” are associated with each other in the example of FIG. 6 (a), the complement unit 23 extracts a record in which Active structure “customer” and Behavior “apply for service” are associated with each other from the practice data 2. In a case where there is no exactly matching record, the complement unit 23 may perform replacement with a synonym and perform searching. In addition, the complement unit 23 may search the practice data 2 for a record in which terms similar to Active structure “customer” and Behavior “apply for service” are set.

The complement unit 23 specifies a term set in the missing element 14 from the extracted record. In the example of FIG. 6 (a), since the object is missing, the complement unit 23 specifies a term of Passive structure corresponding to the object. The complement unit 23 sets the specified term in the service operation data 13. As illustrated in FIG. 6 (b), “client code, client name, client address” is set as the object of the service operation data 13, and the three elements: the subject, the verb, and the object are obtained.

Here, the complement unit 23 may search for a record by referring to each practice data 2 included in the practice data group 20, or may search for a record by referring to predetermined practice data 2. When the industry identifier is acquired from the user, the complement unit 23 specifies the identifier of the practice data 2 associated with the industry type identifier acquired by the acquisition unit 21 from the industry practice data 11. The complement unit 23 extracts a record from the specified practice data 2. The complement unit 23 can extract a record with reference to the practice data 2 related to the industry of the business process to be realized by the user. The complement unit 23 can more quickly and appropriately search for a record that complements the missing element 14.

It is sufficient if the complement unit 23 can refer to at least one practice data 2. In a case where the practice data group 20 includes a plurality of practice data 2 for one industry, the complement unit 23 may determine the practice data to be referred to according to a predetermined rule, such as referring to the practice data 2 closer to the maturation level of the business process of the user, referring to the practice data 2 with a higher or lower maturation level, or the like.

In addition, in a case where an appropriate record cannot be searched with reference to certain practice data 2, the complement unit 23 may search a plurality of practice data such as practice data of another maturation level of the same industry or practice data of another industry in a cross-cutting manner.

In addition to the method of complementing with reference to the practice data 2 as described above, the complement unit 23 also has a method of inquiring the user. When there is a missing element 14 in the service operation data 13, the user may be notified that there is the missing element 14, and an inquiry may be made as to whether the user itself performs the complementation or the processing device 1 performs the complementation. In a case where the user itself performs the complementation, the complement unit 23 generates the service operation data 13 according to data newly input by the user. In a case where the processing device 1 performs the complementation, the complement unit 23 complements the missing element 14 by the method described above.

The generation unit 24 generates the drawing data 15 with reference to the template data 12. The drawing data 15 is used to draw a label of a term corresponding to each element at the display position specified by the template data 12 and draw a connector connecting the label of the term in the direction specified by the template data.

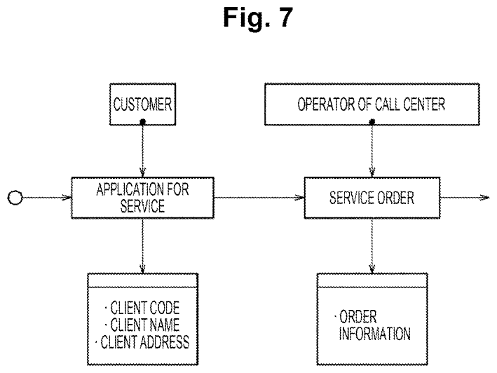

An example of a business architecture drawn by the drawing data 15 will be described with reference to FIG. 7. FIG. 7 depicts the two service operation data 13 illustrated in FIG. 6 (b) when the template data 12 sets the display position of the verb below the display position of the subject and sets the display position of the object below the display position of the verb. On the left side in FIG. 7, three labels are arranged in the up-down direction. These labels correspond to the subject, the verb, and the object in the first service operation data illustrated in FIG. 6 (b) from the top. On the right side in FIG. 7, three labels are arranged in the up-down direction. These labels correspond to the subject, the verb, and the object in the second service operation data illustrated in FIG. 6 (b) from the top.

The template data 12 may be set such that the display position related to each service operation is displayed from left to right in the order in which the service operation data is input. In a case where the service operation data is input in order from the top in FIG. 6 (b), as illustrated in FIG. 7, the drawing data 15 displays the first service operation on the left side, and displays the second service operation on the right side of the display portion of the first service operation.

The template data 12 may be set to display an arrow from the display portion of the verb of certain service operation data to the display portion of the verb of the next service operation data. As illustrated in FIG. 7, the drawing data 15 displays arrows from the display portion of the verb “apply for service” of the first service operation data to the display portion of the verb “service order” of the second service operation data.

The generation unit 24 generates the drawing data 15 visualizing the service operation data 13 and provides the generated drawing data 15 to the drawing terminal 3. The drawing unit 31 of the drawing terminal 3 draws the drawing data 15 and displays the diagram illustrated in FIG. 7 or the like. The setting of the template data 12 illustrated here is an example, and it is not limited thereto.

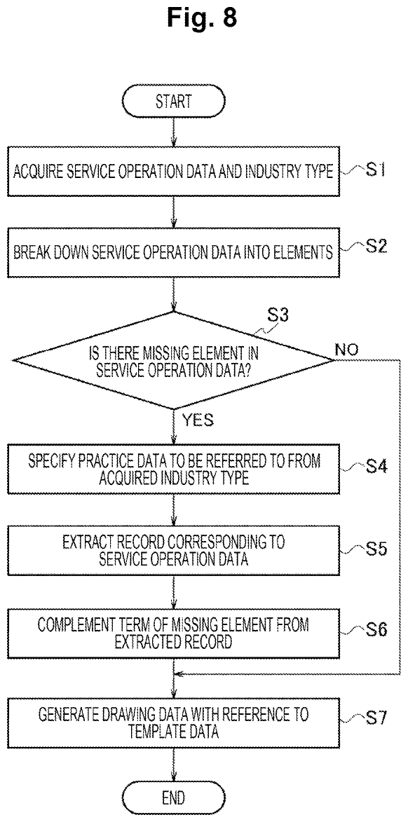

A processing method by the processing device 1 according to the embodiment of the present invention is described with reference to FIG. 8.

In step S1, the processing device 1 acquires the service operation data 13 and the industry type from the user. In step S2, the processing device 1 breaks down the service operation data into elements. In step S3, the processing device 1 determines whether or not there is a missing element in the service operation data 13 acquired in step S1. In a case where there is no missing element, the processing proceeds to step S7.

In a case where there is a missing element, the processing proceeds to step S4. In step S4, the processing device 1 specifies practice data 2 to be referred to, from the industry type acquired in step S1. In step S5, the processing device 1 extracts a record corresponding to the service operation data 13 acquired in step S1 from the practice data 2 specified in step S4. In step S6, the processing device 1 extracts the term of the missing element 14 from the record extracted in step S5. The processing device 1 complements the service operation data 13 with the extracted term.

In step S7, the processing device 1 generates the drawing data 15 with reference to the service operation data 13 and the template data 12.

With the processing device 1 according to the embodiment of the present invention, in a case where there is a missing element 14 in the generation of the business architecture in the service operation data 13 input from the user, the missing element 14 can be complemented from the practice data 2 that accumulates past business processes. The processing device 1 can collect data necessary for generating a business architecture without imposing an excessive burden on the user.

The processing device 1 generates the drawing data 15 for drawing a business architecture with reference to the template data 12. The processing device 1 can generate a diagram of a business architecture without bothering the user.

As described above, the processing device 1 can support the generation of the business architecture.

As the processing device 1 of the present embodiment described above, for example, a general-purpose computer system including a central processing unit (CPU, processor) 901, the memory 902, the storage 903 (hard disk drive (HDD), solid state drive (SSD)), a communication device 904, an input device 905, and an output device 906 is used. In the computer system, each function of the processing device 1 is implemented by the CPU 901 executing a program loaded on the memory 902.

Note that the processing device 1 may be implemented by one computer, or may be implemented by a plurality of computers. In addition, the processing device 1 may be a virtual machine that is implemented in a computer.

The program of the processing device 1 can be stored in a computer-readable recording medium such as an HDD, an SSD, a universal serial bus (USB) memory, a compact disc (CD), or a digital versatile disc (DVD), or can be distributed via a network.

Note that the present invention is not limited to the above embodiment, and various modifications can be made within the scope of the gist of the present invention.

### REFERENCE SIGNS LIST

1 Processing device
2 Practice data
3 Drawing terminal
11 Industry practice data
12 Template data
13 Service operation data
14 Missing element
15 Drawing data
20 Practice data group
21 Acquisition unit
22 Specification unit
23 Complement unit
24 Generation unit
31 Drawing unit
901 CPU
902 Memory
903 Storage
904 Communication device
905 Input device
906 Output device

1. A processing device comprising:
an acquisition unit, comprising one or more processors, configured to acquire service operation data input from a user, the service operation data including terms related to a business process to be realized;
a specification unit, comprising the one or more processors, configured to break down the terms included in the service operation data into elements comprising a subject, a verb, and an object, and specify a missing element in which the term is not set among the elements; and
a complement unit, comprising the one or more processors, configured to extract a record corresponding to the terms included in the service operation data from practice data in which a plurality of records in which a service operation related to a business process realized in past is associated with elements comprising a subject, a verb, and an object is accumulated, and complement the service operation data with the term of the missing element in the extracted record.

2. The processing device according to claim 1, wherein
the acquisition unit is configured to further acquire an identifier of an industry type related to the business process to be realized from the user, and
the complement unit is configured to specify an identifier of practice data associated with the identifier of the industry type acquired by the acquisition unit from industry practice data in which the identifier of the industry type is associated with the identifier of the practice data in which a record of a service operation related to the industry type is accumulated, and extract the record from the specified practice data.

3. The processing device according to claim 1, wherein the subject, the verb, and the object in the service operation data and the practice data are respectively active structure, behavior, and passive structure in a business architecture of an enterprise architecture.

4. The processing device according to claim 1, further comprising:
a generation unit, comprising the one or more processors, configured to refer to template data specifying a display position of each of the elements and a direction of a connector of each of the elements, draw a label of a term corresponding to each element at the display position specified by the template data, and generate drawing data drawing a connector connecting the label of the term in the direction specified by the template data.

5. The processing device according to claim 4, wherein the template data is configured to set a display position of the verb below a display position of the subject, and set a display position of the object below the display position of the verb.

6. A processing method wherein
acquiring service operation data input from a user, the service operation data including terms related to a business process to be realized;
breaking down the terms included in the service operation data into elements comprising a subject, a verb, and an object, and specifying a missing element in which the term is not set among the elements; and
extracting a record corresponding to the terms included in the service operation data from practice data in which a plurality of records in which a service operation related to a business process realized in past is associated with elements comprising a subject, a verb, and an object is accumulated, and complement the service operation data with the term of the missing element in the extracted record.

7. A non-transitory computer readable medium storing a program, wherein execution of the program causes a computer to function as the processing device according to claim 1.
